(19) United States
(12) Patent Application Publication
(10) Pub. No.: US 2011/0208972 A1
(43) Pub. Date: Aug. 25, 2011

(54) METHOD OF SIGNING A MESSAGE

(75) Inventors: Kai Sui Liu, Singapore (SG); Joonsang Baek, Singapore (SG); Jianying Zhou, Singapore (SG)

(73) Assignee: Agency for Science, Technology and Research

(21) Appl. No.: 12/995,154

(22) PCT Filed: Jan. 22, 2009
(86) PCT No.: PCT/SG09/00031

§ 371 Date: May 5, 2011

Related U.S. Application Data
(60) Provisional application No. 61/057,043, filed on May 29, 2008.

(51) Int. Cl. H04W 12/06; H04L 9/00

(52) U.S. Cl. 713/179

(57) ABSTRACT

A method of signing a message, a base station for a wireless sensor network, a node for a wireless sensor network and a wireless sensor network are provided. The method comprises, generating a secret key for signing the message, the secret key being based on an identity of a signer; generating an offline signature; generating an online signature based on at least the offline signature and the secret key; and wherein the online signature is verifiable using a verification algorithm that does not require a pairing operation.

### FIELD OF INVENTION

The present invention relates broadly to a method of signing a message, to a base station for a wireless sensor network, to a node for a wireless sensor network, to a wireless sensor network, to a computer readable data storage medium having stored thereon computer code means for instructing a computer processor of a base station for a wireless sensor network and to a computer readable data storage medium having stored thereon computer code means for instructing a computer processor of a node for a wireless sensor network.

### BACKGROUND

A wireless sensor network (WSN) is a wireless computer network comprising spatially distributed autonomous devices using sensors to cooperatively monitor physical or environmental conditions, such as temperature, sound, vibration, pressure, motion or pollutants, at different locations. WSNs can be used in commercial and industrial applications to monitor data that are typically difficult or expensive to monitor using wired sensors. For example, WSNs can be used to monitor situations in certain hazardous environments, such as nuclear power plants, where it is not feasible to use wired mechanisms. WSNs can be deployed in wilderness areas for a relatively long time e.g. years (monitoring environmental variables) without the need to recharge/replace their power supplies. WSNs can also form a perimeter around a property and monitor for intruders (e.g. by passing information from one node to the next). In short, there can be many uses for WSNs. Possible applications of WSNs include monitoring, tracking, and controlling. Some specific applications include battlefield surveillance, environment/habitat monitoring, object tracking, nuclear reactor controlling, fire detection, traffic monitoring, healthcare applications, home automation etc.

In a typical setting, a WSN comprises a plurality of nodes communicating with a base station. In an application, a WSN is typically scattered in a region where the WSN is meant to collect data through its sensor nodes. However, WSNs are relatively more vulnerable to attacks as they are often deployed in accessible open-space areas available to attackers. Thus, authentication of information collected by the nodes is desired, making the design of a WSN challenging due to security problems. Additionally, the sensor nodes of a WSN typically have constrained resources e.g. in terms of computation, memory and battery power. These constrains typically only allow light or non-intensive cryptographic operations inside the nodes to be performed. The inventors have recognised that most current cryptographic operations typically rely on heavy or intensive operations that may not be possible to be incorporated in WSN environments.

Asymmetric cryptography has been considered for WSNs because such cryptography does not have a problem of sharing a long-term secret and can facilitate better key management and authentication (e.g. using digital signature schemes). However, it has been recognised that asymmetric cryptography typically needs to perform relatively heavy cryptographic operations (e.g. modulo exponentiation or multiplication operations). Thus, such cryptography is believed to be unsuitable for WSNs.

A discussion of current cryptography systems/processes is provided below.

An identity-based (ID-based) cryptosystem, introduced by Shamir in A. Shamir. Identity-Based Cryptosystems and Signature Schemes. In Proc. CRYPTO 84, volume 196 of Lecture Notes in Computer Science, pages 47-53. Springer-Verlag, 1984, eliminates the necessity for checking validity of certificates. In an ID-based cryptosystem, a public key of each user is computable from a string corresponding to the user's identity (e.g. an email address, a telephone number, etc.). A private key generator (PKG) can compute private keys using a master secret for users. Thus, using the cryptosystem, there is no requirement of using certificates and an implicit public key (based on user identity) is associated to each user within the system. In the case of signature, verification uses only a user identity together with a message and a signature pair as input. The input is used for executing the ID-based cryptosystem algorithm directly. This is in contrast to typical public key cryptography where an additional certification verification algorithm is typically needed. The additional certification verification algorithm is equivalent to a process of two signatures verification.

To reduce computational cost of signature generation, online/offline signatures can be considered. The notion of online/offline signatures was introduced by Even et. al. in S. Even, O. Goldreich, and S. Micali. On-line/offline digital signatures. In Proc. CRYPTO 89, volume 2442 of Lecture Notes in Computer Science, pages 263-277. Springer-Verlag, 1989. The signature generating procedure is performed in two phases. A first phase is performed offline (i.e. prior to knowledge of a message to be signed) and a second phase is performed online (i.e. after knowing the message to be signed). The offline phase is typically used to execute heavy or intensive computations (e.g. exponentiation, pairing) in a server/base station and to produce partial information. The online phase is typically used to execute light computations only (e.g. hashing, addition, multiplication) in devices. The online phase is typically fast, and hence can be executed efficiently using a “weak” processor.

Even et. al. proposed a general method for converting any signature scheme into an online/offline signature scheme. However, the method has been recognised as being impractical since it increases the size of a signature by a quadratic factor. Subsequently, Shamir et. al., in A. Shamir and Y. Tauman. Improved online/offline signature schemes. In Proc. CRYPTO 2001, volume 2139 of Lecture Notes in Computer Science, pages 355-367. Springer-Verlag, 2001, proposed a new paradigm, called “hash-sign-switch”, for designing more efficient online/offline signature schemes. However, both schemes by Even et. al and Shamir et. al are not targeted for identity-based settings.

An identity-based online/offline signature scheme has been designed by Xu et. al. in S. Xu, Y. Mu, and W. Susilo. Online/offline signatures and multisignatures for AVOD and DSR routing security. In ACISP '06, volume 4058 of Lecture Notes in Computer Science, pages 99-110. Springer-Verlag, 2006. This scheme is referred to as the XMS scheme hereafter. In the XMS scheme, a signer is required to execute an offline phase every time a signature is to be produced. This is termed as “one-time”. That is, in the XMS scheme, offline storage can be used only once and cannot be re-used. It is recognised that the XMS scheme is impractical to be applied to a WSN. If the XMS scheme were to be applied to a WSN, the offline phase is to be carried out at the base station of the WSN. Thus, being a “one-time” scheme or having a non-reusable storage would imply that the nodes of the WSN would need to contact the base station every time for obtaining the next offline signature part. Moreover, the verification process of the XMS scheme requires a pairing operation. The pairing operation is inherent in the XMS scheme and the XMS scheme is fundamentally designed based on usage of pairing operations. A person skilled in the art would appreciate that a pairing operation is a costly computation process with respect to a sensor node. It is not expected that a node of a WSN can execute such a heavy or intensive operation. Thus, it has been recognised that the XMS signature scheme is not appropriate for node-to-node signatures in WSNs.

Furthermore, in “On the Security of Online/Offline Signatures and Multisignatures from ACISP'06”, by Fagen Li, Masaaki Shirase and Tsuyoshi Takagi in The 7^{th} International Conference on Cryptology and Network Security (CANS 2008), Pg. 108-119, Lecture Notes in Computer Science Volume 5339, Springer, 2008, Fagen Li et. al. has provided a valid attack on the XMS scheme and showing that the XMS scheme is insecure.

Hence, in view of the above, there exists a need for a method of signing a message, a base station for a wireless sensor network, a node for a wireless sensor network, a wireless sensor network and a computer readable data storage medium having stored thereon computer code means for instructing a computer processor of a base station for a wireless sensor network and a computer readable data storage medium having stored thereon computer code means for instructing a computer processor of a node for a wireless sensor network that seek to address at least one of the above problems.

### SUMMARY

In accordance with a first aspect of the present invention, there is provided a method of signing a message, the method comprising, generating a secret key for signing the message, the secret key being based on an identity of a signer; generating an offline signature; generating an online signature based on at least the offline signature and the secret key; and wherein the online signature is verifiable using a verification algorithm that does not require a pairing operation.

The verification algorithm may be based on an inequality equation using the identity of the signer, the secret key, the message and the online signature.

The generating the online signature may be further based on the message.

The offline signature may be re-usable for signing multiple messages.

The generating the offline signature may not be based on the secret key, such that a party not holding the secret key is capable of generating the offline signature.

The method may further comprise, providing a set of public parameters param and a master secret key msk: param=(G,q,g,X,H) and msk=x; wherein G is a multiplicative group with order q, gεG, xεZ*_{q}, X=g^{x} and H:{0,1}*→Z*_{q} is a cryptographic hash function.

The generating the secret key may comprise computing: R←g^{r} and s←r+H(R,ID)x mod q; wherein the secret key is denoted as (R,s), the identity of said signer is denoted as ID and rεZ*_{q}.

The generating the offline signature may comprise computing Ŷᵢ←g⁻²^{ⁱ} for i=0, . . . |q|−1

The generating the online signature may comprise computing:

$$Y ← {\prod }_{i ∈ Ψ} {\hat{Y}}_{i - 1} ;$$

h←H(Y,R,m) and z←y+hs mod q; wherein yεZ*_{q}, y[i] is an i-th bit of y, Ψ⊂{1, . . . , |q|} is denoted as a set of indices such that y[i]=1 and the message is denoted as m; further wherein the online signature is denoted as (Y,R,z).

The verification algorithm may comprise computing h←H(Y,R,m); and checking whether g^{z}^{^{?}}=YR^{h}X^{hH(R,ID)}.

The method may further comprise applying an aggregation algorithm to a plurality of messages for deriving the online signature in an aggregated form, said aggregated form comprising a signature part that varies corresponding to each one of the plurality of messages.

The method may further comprise providing a set of public parameters param and a master secret key msk: param=(G,q,g,X,H) and msk=x; wherein G is a multiplicative group with order q, gεG, xεZ*_{q}, X=g^{x} and H:{0,1}*→Z*_{q}; is a cryptographic hash function.

The generating the secret key may comprise computing: R←g^{r} and s←r+H(R,ID)x mod q; wherein the secret key is denoted as (R,s), the identity of said signer is denoted as ID and rεZ*_{q}.

The generating the offline signature may comprise computing Ŷᵢ←g⁻²^{ⁱ} for i=0, . . . |q|−1.

The deriving the online signature in an aggregated form may comprise computing:

$${Y}_{l} ← {\prod }_{i ∈ {Ψ}_{l}} {\hat{Y}}_{i - 1} ;$$

hₗ←H(Y,R,mₗ), zₗ←yₗ+hₗs mod q and

$$z = {\sum }_{l = 1}^{n} {z}_{l} ;$$

wherein l=1, . . . , n, yεZ*_{q}, yₗ[i] is an i-th bit of yₗ, Ψₗ⊂{1, . . . , |q|} is denoted as a set of indices such that yₗ[i]=1 and mₗ denotes the plurality of messages for l=1, . . . , n, further wherein the online signature in an aggregated form is denoted as (Yₗ,R,z) for l=1, . . . , n.

The verification algorithm may comprise computing hₗ←H(Y,R,mₗ); and checking whether

$${g}^{z} {=}^{?} ( {\prod }_{l = 1}^{n} {Y}_{l} ) {R}^{{\sum }_{l = 1}^{n} {h}_{l}} {X}^{( {\sum }_{l = 1}^{n} {h}_{l} ) H ( R , ID )}$$

The offline signature may be generated based on the secret key.

In accordance with a second aspect of the present invention, there is provided a base station for a wireless sensor network, the base station comprising, a private key generator for generating a secret key, the secret key being based on an identity of a node; an offline signature generator for generating an offline signature; and a verification module for verifying an online signature generated by a signer for signing a message using a verification algorithm that does not require a pairing operation.

The verification algorithm may be based on an inequality equation using an identity of the signer, a secret key of the signer, the message sent from the signer and the online signature generated by the signer.

The offline signature may be re-usable for signing multiple messages.

The generating the offline signature may not be based on the secret key, such that a party not holding the secret key is capable of generating the offline signature.

The private key generator may provide a set of public parameters param and a master secret key msk: param=(G,q,g,X,H) and msk=x; wherein G is a multiplicative group with order q, gεG, xεZ*_{q}, X=g^{x} and H:{0,1}*→Z*_{q} is a cryptographic hash function.

The private key generator may generate the secret key of the node by computing: R←g^{r} and s←r+H(R,ID)x mod q; wherein the secret key is denoted as (R,s), the identity of the node is denoted as ID and rεZ*_{q}.

The offline signature generator may generate the offline signature by computing Ŷᵢ←g⁻²^{ⁱ} for i=0, . . . |q|−1.

The verification module may verify the online signature generated by the signer by: computing h←H(Y,R,m); and checking whether g^{z}^{^{?}}=YR^{h}X^{hH(R,ID)}; wherein the message sent from the signer is denoted as m, the secret key of the signer is denoted as (R,s), the identity of the signer is denoted as ID and the online signature of the signer is denoted as (Y,R,z).

The verification module may be capable of verifying an online signature in aggregated form (Y_{L},R,z) generated by a signer for signing a plurality of messages mₗ for l=1, . . . , n; and wherein the verification module may verify the online signature in aggregated form by: computing hₗ←H(Y,R,mₗ); and checking whether

$${g}^{z} {=}^{?} ( {\prod }_{l = 1}^{n} {Y}_{l} ) {R}^{{\sum }_{l = 1}^{n} {h}_{l}} {X}^{( {\sum }_{l = 1}^{n} {h}_{l} ) H ( R , ID )} .$$

The generating the offline signature may be based on the secret key.

In accordance with a third aspect of the present invention, there is provided a node for a wireless sensor network, the node comprising, a receiver for receiving a secret key, an offline signature and a set of public parameters, the secret key being based on an identity of the node; an online signature generator for generating an online signature based on at least the offline signature and the secret key, the online signature for signing a message; wherein the online signature is verifiable using a verification algorithm that does not require a pairing operation.

The verification algorithm may be based on an inequality equation using the identity of the node, the secret key, the message and the online signature.

The generating the online signature may be further based on the message.

The offline signature may be re-usable for signing multiple messages.

The offline signature may not be based on the secret key, such that a party not holding the secret key is capable of generating the offline signature.

The receiver may receive the secret key denoted as (R,s), the set of public parameters denoted as param=(G,q,g,X,H) and the offline signature denoted as Ŷᵢ←g⁻²^{ⁱ} for i=0, . . . |q|−1.

The online signature generator may generate the online signature by computing

$$Y ← {\prod }_{i ∈ Ψ} {\hat{Y}}_{i - 1} ;$$

h←H(Y,R,m) and z←y+hs mod q; wherein yεZ*_{q}, y[i] is an i-th bit of y, Ψ⊂{1, . . . , |q|} is denoted as a set of indices such that y[i]=1 and the message is denoted as m; further wherein the online signature is denoted as (Y,R,z).

The online signature generator may be capable of applying an aggregation algorithm to a plurality of messages for deriving the online signature in an aggregated form, said aggregated form comprising a signature part that varies corresponding to each one of the plurality of messages.

The deriving the online signature in an aggregated form may comprise computing:

$${Y}_{l} ← {\prod }_{i ∈ {Ψ}_{l}} {\hat{Y}}_{i - 1} ;$$

hₗ←H(Y,R,mₗ), zₗ←yₗ+hₗs mod q and

$$z = {\sum }_{l = 1}^{n} {z}_{l} ;$$

wherein the set of public parameters is param=(G,q,g,X,H), the set of l=1, . . . , n, yεZ*_{q}, yₗ[i] is an i-th bit of yₗ, Ψₗ⊂{1, . . . , |q|} is denoted as a set of indices such that yₗ[i]=1 and mₗ denotes the plurality of messages for l=1, . . . , n, further wherein the online signature in an aggregated form is denoted as (Yₗ,R,z) for l=1, . . . , n.

The node may further comprise a verification module for verifying an online signature generated by a signer for signing a message using a verification algorithm that does not require a pairing operation.

The verification module may verify the online signature generated by the signer by: computing h←H(Y,R,m); and checking whether

$${g}^{z} {=}^{?} {YR}^{h} {X}^{hH ( R , ID )} ;$$

wherein the set of public parameters is param=(G,q,g,X,H), the received message sent from the signer is denoted as m, a secret key of the signer is denoted as (R,s), an identity of the signer is denoted as ID and the online signature of the signer is denoted as (Y,R,z).

The verification module may be capable of verifying an online signature in aggregated form (Yₗ,R,z) generated by a signer for signing a plurality of messages mₗ for l=1, . . . , n; and wherein the verification module may verify the online signature in aggregated form by: computing hₗ←H(Y,R,mₗ); and checking whether

$${g}^{z} {=}^{?} ( {\prod }_{l = 1}^{n} {Y}_{l} ) {R}^{{\sum }_{l = 1}^{n} {h}_{l}} {X}^{( {\sum }_{l = 1}^{n} {h}_{l} ) H ( R , ID )} ;$$

wherein the set of public parameters is param=(G,q,g,X,H).

The node may further comprise an offline signature generator for generating the offline signature internal the node.

The generating the offline signature may be based on the secret key.

In accordance with a fourth aspect of the present invention, there is provided a wireless sensor network, the network comprising, a base station; and one or more wireless sensor nodes; wherein the base station comprises, a private key generator for generating a secret key, the secret key being based on an identity of a node; an offline signature generator for generating an offline signature; and a verification module for verifying an online signature generated by a signer for signing a message using a verification algorithm that does not require a pairing operation; and at least one wireless sensor node comprises, a receiver for receiving a secret key, an offline signature and a set of public parameters, the secret key being based on an identity of the node; an online signature generator for generating an online signature based on at least the offline signature and the secret key, the online signature for signing a message; wherein the online signature is verifiable using a verification algorithm that does not require a pairing operation.

In accordance with a fifth aspect of the present invention, there is provided a computer readable data storage medium having stored thereon computer code means for instructing a computer processor of a base station for a wireless sensor network to execute the steps of generating a secret key, the secret key being based on an identity of a node; generating an offline signature; verifying an online signature generated by a signer for signing a message using a verification algorithm that does not require a pairing operation.

In accordance with a sixth aspect of the present invention, there is provided a computer readable data storage medium having stored thereon computer code means for instructing a computer processor of a node for a wireless sensor network to execute the steps of receiving a secret key, an offline signature and a set of public parameters, the secret key being based on an identity of the node; generating an online signature based on at least the offline signature and the secret key, the online signature for signing a message; wherein the online signature is verifiable using a verification algorithm that does not require a pairing operation.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1(a) is a schematic drawing illustrating a wireless sensor network (WSN) in an Extract phase in an example embodiment.

FIG. 1(b) is a schematic drawing illustrating the WSN in an offline stage in the example embodiment.

FIG. 1(c) is a schematic drawing illustrating the WSN in an online stage in the example embodiment.

FIG. 1(d) is a schematic drawing illustrating the WSN in a verification phase in the example embodiment.

FIG. 2 is a schematic drawing illustrating a data format of a packet in the example embodiment.

FIG. 3(a) is a schematic drawing illustrating a wireless sensor network (WSN) in another example embodiment.

FIG. 3(b) is a schematic illustration of a broadcast message in the example embodiment.

FIG. 3(c) is a schematic illustration of a data transmission in the example embodiment.

FIG. 4 is a schematic flowchart for illustrating a method of signing a message in an example embodiment.

FIG. 5 is a schematic diagram for illustrating a base station for a wireless sensor network in an example embodiment.

FIG. 6 is a schematic diagram for illustrating a node for a wireless sensor network in an example embodiment.

### DETAILED DESCRIPTION

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

The invention may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

In the example embodiments described below, an online/offline identity-based signature scheme can be provided for use in a wireless sensor network (WSN) environment. The example embodiments can provide significant reduction of computational and storage costs and thus, can be suited to the WSN environment where computational resources are typically constrained. The example embodiments can provide multi-time usage of an offline storage which allows a signer to re-use offline pre-computed information in polynomial time. This is in contrast to one-time usage in current online/offline signature schemes.

An example embodiment is described below. The example embodiment can provide an offline signature part that can be used multi-times.

In the example embodiment, at a Setup phase, let G be a multiplicative group with order q. A private key generator (PKG) selects a random generator gεG and randomly chooses xεZ*_{q}. The PKG sets X=g^{x}. Let H:{0,1}*→Z*_{q} be a cryptographic hash function. The public parameters param and master secret key msk are given by

param=(G,q,g,X,H) (1)

msk=x (2)

At an Extract phase, to generate a secret key for a user/node identity ID, the PKG randomly selects rεZ*_{q} and computes

R←g^{r} (3)

s←r+H(R,ID)x mod q (4)

In the example embodiment, a user secret key is (R,s). A correctly generated secret key fulfils the following equality:

g^{s}=RX^{H(R,ID)} (5)

At an offline signature generation phase, i.e. at an offline stage, a signer computes:

Ŷᵢ←g⁻²^{ⁱ} for i=0, . . . . |q|−1. (6)

It is noted that at the offline stage, knowledge of a message (to be signed) or the secret key are not required. Thus, equation (6) can be computed by a third party. Alternatively, the offline signature of equation (6) can be regarded as part of the public parameters (compare equation (1)) and can be prepared by the PKG, instead of being prepared at a separate offline stage.

At an online signature phase, i.e. at an online stage, the signer randomly selects yεZ*_{q}. Let y[i] be the i-th bit of y. Define Ψ⊂{1, . . . , |q|} to be the set of indices such that y[i]=1. Denote m as the message. Compute

$$\begin{matrix}Y ← {\prod }_{i ∈ Ψ} {\hat{Y}}_{i - 1} & ( 7 ) \\ h ← H ( Y , R , m ) & ( 8 ) \\ z ← y + hs mod q & ( 9 )\end{matrix}$$

In the example embodiment, the signature is (Y,R,z).

At a verification phase at a verifier, to verify the signature (Y,R,z) for a message m and a signer identity ID, the verifier first computes h←H(Y,R,m) and checks whether

$${g}^{z} {=}^{?} {YR}^{h} {X}^{hH ( R , ID )} \qquad ( 10 )$$

The verifier accepts the message if equation (10) is equal/correct. Otherwise, the verifier rejects the message.

In the above example embodiment, for implementation in a WSN, the offline phase can be executed at a base station while the online phase can be executed in a WSN node.

Provided below is a description on how the verification equation (10) is arrived at. It is noted that Y=g^{y}. Thus,

$$\begin{matrix}{YR}^{h} {X}^{hH ( R , ID )} = {g}^{y} {g}^{rh} {g}^{xhH ( R , ID )} \\ = {g}^{y + h ( r + H ( R , ID ) x )} \\ = {g}^{y + hs} \\ = {g}^{z}\end{matrix}$$

Therefore, if the verifier can verify that g^{z} is equal to YR^{h}X^{hH(R,ID)} using the signature (Y,R,z) from the message sent from a node with identity ID, the signature is verified as correct.

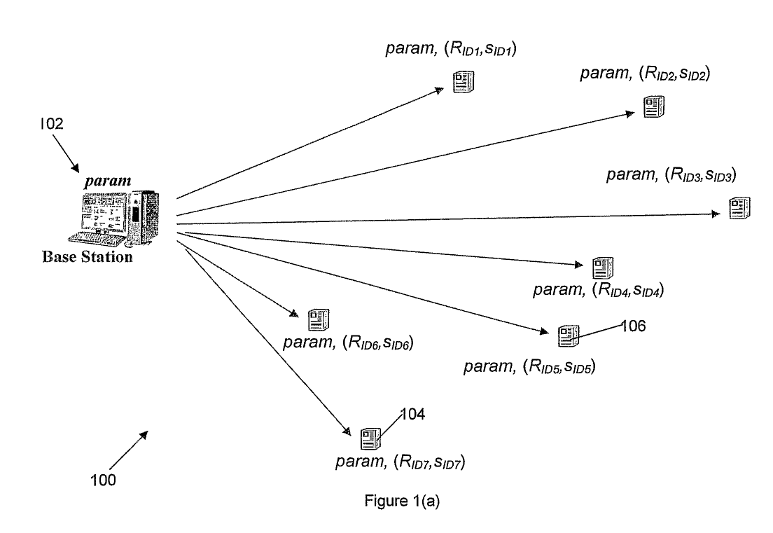

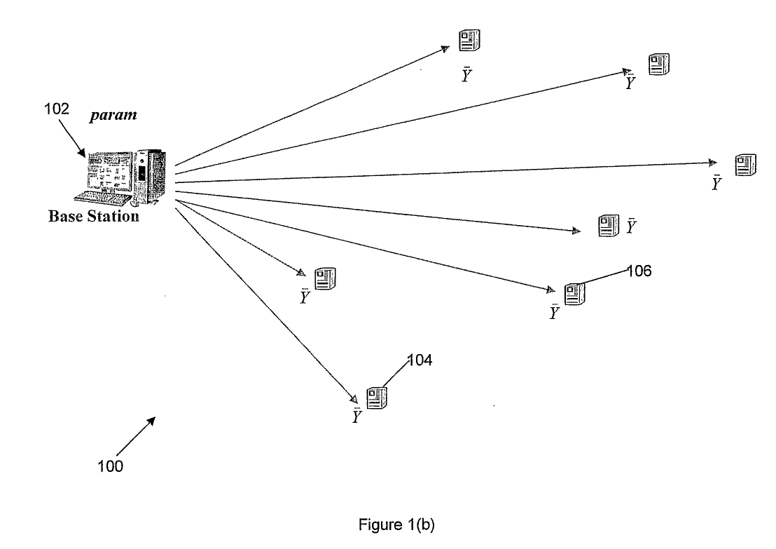

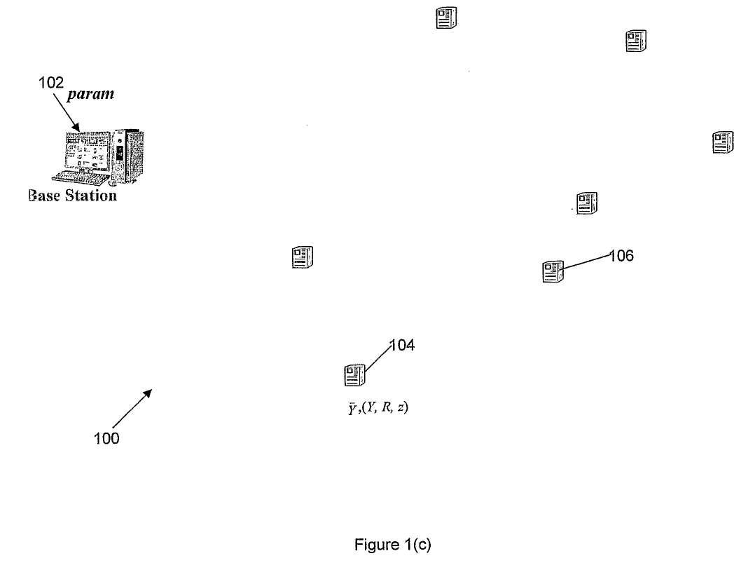

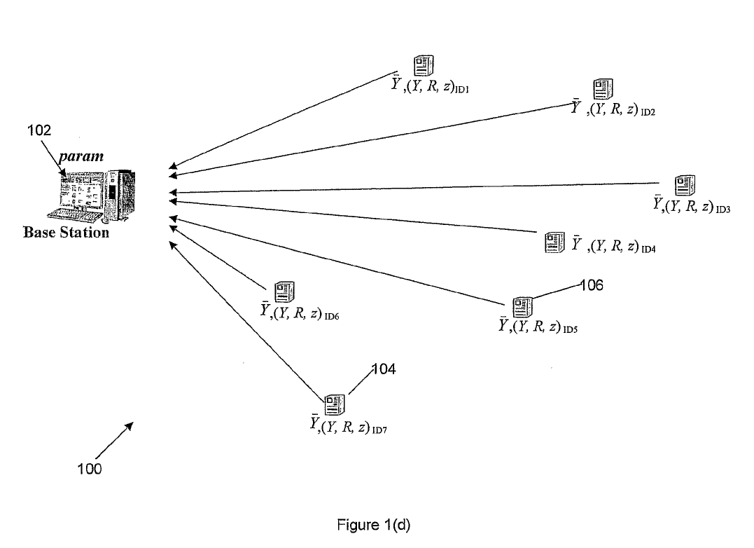

FIGS. 1(a) to (d) are schematic drawings illustrating a wireless sensor network (WSN) in another example embodiment. The WSN 100 comprises a base station 102 and one or more sensor nodes e.g. 104, 106. With reference to FIG. 1(a), the base station 102 generates param to the sensor nodes e.g. 104, 106. During an Extract phase, the base station 102 generates and distributes a secret key for each sensor node e.g. 104, 106. Each respective secret key is associated with an identity ID of the sensor node e.g. 104, 106. For example, for the sensor node 106 with ID5, a secret key (R_{ID5},S_{ID5}) is generated and distributed to the sensor node. Compare also equations (3) and (4).

In the example embodiment, the base station 102 is tasked to generate the offline signature part for the sensor nodes e.g. 104, 106. With reference to FIG. 1(b), during an offline stage, the base station 102 generates an offline signature part Y̅ and distributes Y̅ to the sensor nodes e.g. 104, 106. Compare equation (6). In the example embodiment, Y̅ is not dependent on the identity ID of each sensor node e.g. 104, 106 and can be identical.

In the example embodiment, for a sensor node e.g. 104, 106 to send a message m, the sensor node e.g. 104, 106 generates its online signature part (Y,R,z). With reference to FIG. 1(c), during an online stage, for example for the sensor node 106, its online signature part (Y,R,z) is generated for message m. Compare equations (7), (8) and (9).

In the example embodiment, the verification of signatures is carried out at the base station 102. With reference to FIG. 1(d), the sensor nodes e.g. 104, 106 that communicate with the base station 102 transmit their respective messages with their respective signatures for verification. For example, for the sensor node 106, the signature (Y,R,z)_{ID5} is transmitted to the base station 102. The base station 102 then carries out verification of the signature. Compare equation (10). It will be appreciated that the verification is not limited to the base station and can include verification of signatures being carried out by the sensor nodes e.g. 104, 106, e.g. during node-to-node communications.

The above example embodiment can be conducted on a WSN platform that is MicaZ, developed by Crossbow Technology. The radio-frequency (RF) transceiver for MicaZ complies with the so-called IEEE 802.15.4/ZigBee standard and uses an 8-bit microcontroller Atmel ATmegal28L. The microcontroller or central processing unit runs at about 7.37 MHz and comprises 128 kB code and a 4kB data memory (in EEPROM). A flash memory of 512 kB and a power supply of about 2700 mAh are also provided. A personal computer PC (Dell Dimension 9150 3.0 GHz (Intel Core 2) CPU, 1 GB RAM) is used as a base station.

The programming languages used for the example embodiment implementation are nesC (for the nodes), C (for the cryptolibrary) and Java (for the interlace). nesC is substantially used for programming on MicaZ. The base operating system for the MicaZ platform is TinyOS 2.0. The ECC component of the signature scheme of the above example embodiment is based on the Siemens AG's ECC library. The signature size is about 160 bits.

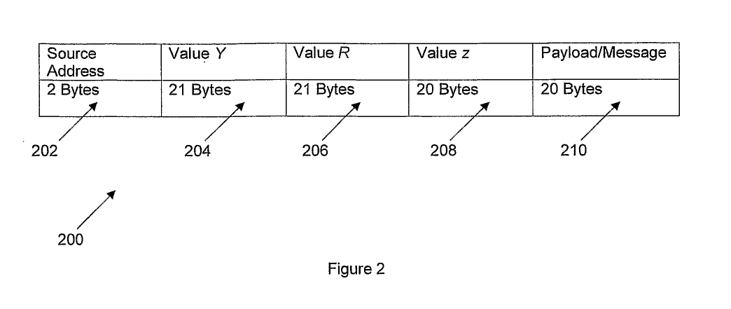

FIG. 2 is a schematic drawing illustrating a data format of a packet in the example embodiment. The size of the packet 200 is about 84 bytes comprising 2 bytes for a header showing source address 202, 42 bytes for a signature (comprising 21 bytes for Y 204, 21 bytes for R 206, 20 bytes for z 208) and 20 bytes for a payload 210.

An analysis of the computational overhead of the example embodiment is provided. Table 3 below tabulates the time and energy consumption of the example embodiment when a random message of 20 bytes is signed and verified.

TABLE 3

| Process | Time(s) | Energy (mJ) |
|---|---|---|
| Sign | 0.896 | 13.744 |
| Verify | 4.321 | 66.264 |

The verification time is about 4 seconds.

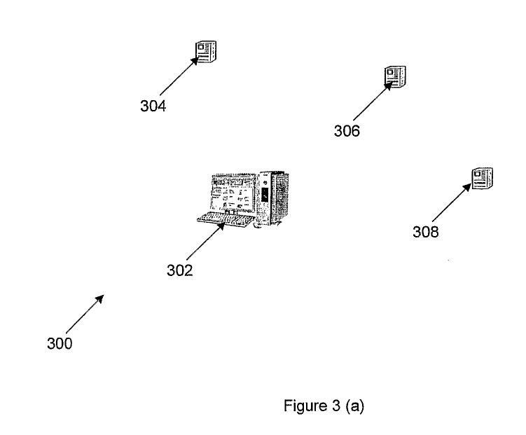

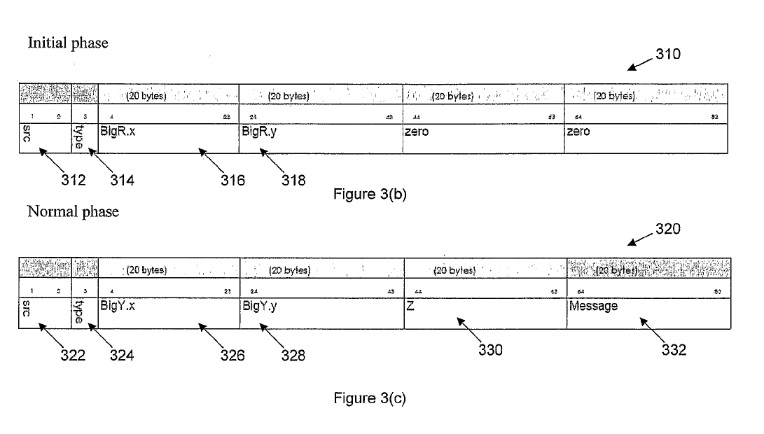

FIG. 3(a) is a schematic drawing illustrating a wireless sensor network (WSN) in another example embodiment. The WSN 300 comprises a base station 302 and a plurality of sensor nodes 304, 306, 308. Each of the base station 302 and the sensor nodes 304, 306, 308 are communication devices capable of communicating and verifying messages. In this example embodiment, the fact that R is the same for every signature for each sensor node 304, 306, 308 is exploited for splitting communication into two phases (ie. an initial phase and a normal phase).

In the example embodiment, Elliptic curve cryptography is used. As R and Y are points in an Elliptic curve, x-y coordinates are used to represent each R and each Y in Cartesian space.

In the example embodiment, each sensor node 304, 306, 308 broadcasts its own R_{ID}·x and R_{ID}·y during the initial phase.

FIG. 3(b) is a schematic illustration of a broadcast message in the example embodiment. The broadcast message 310 comprises an identity ID 312 of the respective sensor node, a message type 314, R_{ID}·x 316 and R_{ID}·y 318. The broadcast message 310 length is about 43 bytes. After broadcasting the broadcast message, each sensor node 304, 306, 308 proceeds to listen/poll for any incoming message.

For sending a message, a sensor node e.g. 304, 306, 308 sends a data transmission comprising its own Y·x, Y·y and z during the normal phase.

FIG. 3(c) is a schematic illustration of a data transmission in the example embodiment. The data transmission 320 comprises an identity ID 322 of the respective sensor node, a message type 324, Y·x 326, Y·y 328, z 330 and the message 332. The data transmission 320 length is about 83 bytes.

Thus, from the broadcast message 310 and the data transmission 320, the message m, the identity ID and the signature (Y,R,z) can be obtained. At each sensor node 304, 306, 308, when an incoming message is received, the sensor node e.g. 304, 306, 308 checks whether it has stored the R_{ID} (ie. comprising R_{ID}·x and R_{ID}·y) of the corresponding sensor ID (compare numerals 312 and 322). If R_{ID}·x and R_{ID}·y are available, the sensor node e.g. 304, 306, 308 proceeds with verification of the signature (Y,R,z). If R_{ID}·x and R_{ID}·y are not available, the sensor node e.g. 304, 306, 308 requests the transmitting sensor node e.g. 304, 306, 308 to re-send its R_{ID}.

The security of the signature scheme of the example embodiments can be related to the hardness of the discrete logarithm (DL) problem in the group in which the signature is constructed. Before discussing the security of the example embodiments, some definitions are provided as follows.

A definition for a Discrete Logarithm (DL) Assumption is provided. Given a group G of prime order q with generator g and element g^{x}εG where x is selected uniformly at random from Z_{q}^{q}, the discrete logarithm (DL) problem in G is to compute x. The (ε,t)-DL assumption holds in a group G if no algorithm running in time at most t can solve the DL problem in G with probability at least ε.

A definition for an ID-based signature scheme IDS is provided. An ID-based signature scheme IDS generally comprises algorithms Setup, Extract, Sign and Verify. A Setup algorithm computes a PKG's public parameters param and a master key msk. param is given to all parties involved in the scheme while msk is kept secret. An Extract algorithm provides that, given an identity ID, this algorithm generates a private key associated with ID using msk, denoted by sk_{ID}. A Sign algorithm provides that, on input of the private key sk_{ID} and a message m, this algorithm generates a signature σ of the message m. A Verify algorithm provides that, given ID, m and σ, this algorithm outputs “accept” if the signature σ is valid and outputs “reject” otherwise.

Further, the inventors have provided an unforgeability notion for an IDS termed as “UF-IDS-CMA (or Unforgeability of IDS under chosen message attack)”.

A definition for UF-IDS-CMA is provided. The inventors recognise that an ID-based signature scheme IDS=(Setup, Extract, Sign, Verify) is secure in the sense of UF-IDS-CMA if there is no adversary F, whose running time is polynomial bounded and given the set of common parameters param generated by Setup, that succeeds in the following attack process with non-negligible probability. In the attack process, the adversary F interacts with a challenger.

At a first step, when F issues a private key extraction query by providing ID as identity, the challenger runs the Extract algorithm providing ID as input, obtains a corresponding private key sk_{ID} and responds to F with the private key. At a second step, when F issues a signature generation query comprising an identity ID and a message m, the challenger runs the Extract algorithm providing ID as input, obtains a corresponding private key sk_{ID}. The challenger then runs the Sign algorithm providing sk_{ID} as input and transmits a resulting signature σ to F. At a third step, at the end of the process, F outputs (ID′,m′,σ′), where σ′ is a valid signature of a message m′ and ID′ is a corresponding identity. A restriction here is that ID′ and m′ have not been issued as part of any of the private key extraction and signature generation queries previously.

An “advantage” of an adversary is defined as the probability that the adversary wins the above attack process. An adversary is said to be an (ε,t,qₑ,qₛ,qₕ)-forger if it has “advantage” at least in the above process, runs in time at most t, and makes at most qₑ, qₛ and qₕ, extract, signing and random oracle queries, respectively. Thus, a scheme is said to be (ε,t,qₑ,qₛ,qₕ)-secure (UF-IDS-CMA) if no (ε,t,qₑ,qₛ,qₕ)-forger exists.

Following the above definitions, a security analysis and an efficiency analysis of the signature scheme of the example embodiments is provided below.

The inventors set out to show that the signature scheme is (ε,t,qₑ,qₛ,qₕ)-existential UF-IDS-CMA in a random oracle model, assuming that the (ε′,t′)-DL assumption holds in G, where

$$\begin{matrix}{ɛ}^{′} = ( 1 - \frac{{q}_{h} ( {q}_{e} + {q}_{s} )}{q} ) ( 1 - \frac{1}{q} ) ( \frac{1}{q} ) ɛ & ( 11 ) \\ {t}^{′} = t + O ( {q}_{e} + {q}_{s} ) E & ( 12 )\end{matrix}$$

and qₑ,qₛ, qₕ are the numbers of extraction, signing and hashing queries respectively, an adversary is allowed to make and E is the time for an exponentiation operation.

Assume that there exists a forger A. An algorithm B is constructed that makes use of A to solve discrete logarithm problems. B is given a multiplicative group G with generator g and order q, and a group element AεG. B is tasked to find αεZ_{q} such that g^{α}=A.

At a Setup phase, B chooses a hash function H:{0,1}*→Z*_{q}, which behaves like a random oracle. B is responsible for the simulation of this random oracle. B assigns X←A and outputs the public parameter param=(G,q,g,X,H) to A.

At an extraction oracle phase, A is allowed to query an extraction oracle for an identity ID. B simulates the extraction oracle as follows. B randomly chooses a,bεZ_{q} and sets

R←X^{a}g^{b}, s←b, H(R,ID)←−a

A key (R,s) generated in this way satisfies the equation (5) in the Extract algorithm. It is a valid secret key. B outputs (R,s) as the secret key of ID and stores the value of (R,s,H(R,ID),ID) in a table for consistency.

At a signing oracle phase, A queries a signing oracle for a message in and an identity ID. B first checks whether ID has been queried for the random oracle H or the extraction oracle previously. On one hand, if ID has been queried previously, B retrieves (R,s,H(R,ID)) from the table and uses these values to sign the message, according to the signing algorithm of the signature scheme. B outputs the signature (Y,R,z) for the message in and stores the value H(Y,R,m) in a hash table for consistency. On the other hand, if ID has not been queried to the extraction oracle previously, B executes a simulation of the extraction oracle and uses the corresponding secret key to sign the message.

At an output calculation phase, the adversary A outputs a forged signature σ*₍₁₎=(Y*,R*,z*₍₁₎) on message m* and identity ID*. B returns A to a point where A queries H(Y*,R*,m*) and supplies A with a different value. A outputs another pair of signature σ*₍₂₎=(Y*,R*,z*₍₂₎). B repeats to run A and obtains σ*₍₃₎=(Y*,R*,z*₍₃₎) from A. It is noted that Y* and R* are the same every time. Let c₁,c₂,c₃ be the output of the random oracle queries H(Y*,R*,m*) for the first, second and third time, respectively.

By selecting r,x,yεZ_{q}, discrete logarithms of X,Y,Z respectively are denoted, i.e., g^{r}=R, g^{x}=X and g^{y}=Y. Using equation (10),

z*₍ᵢ₎=y+rcᵢ+xcᵢH(R*,ID)mod q for i=1,2,3

In these equations, only r,y,x are unknown to B. B solves for these values from the above three linear independent equations and outputs x as the solution of the discrete logarithm problem.

A probability analysis is carried out below. The simulation of the extraction oracle fails if the random oracle assignment H(R,ID) causes inconsistency. Failure happens with a probability of at most qₕ/q. Hence, the simulation is successful qₑ+qₛ times (since H(R,ID) may also be queried in the signing oracle if ID has not been queried in the extraction oracle) with a probability of at least

$${( 1 - \frac{{q}_{h}}{q} )}^{{q}_{e} + {q}_{s }} \geq 1 - \frac{{q}_{h} ( {q}_{e} + {q}_{s} )}{q} .$$

Due to the ideal randomness of the random oracle, there exists a query H(R*,Y*,m*) with a probability of at least 1−1/q. B can guess the query results correctly as the point of rewind with a probability of at least 1/qₕ. Thus, the overall successful probability is

$$( 1 - \frac{{q}_{h} ( {q}_{e} + {q}_{s} )}{q} ) ( 1 - \frac{1}{q} ) ( \frac{1}{{q}_{h}} ) ɛ . ( Compare equation ( 11 ) )$$

The time complexity of the algorithm B is dominated by the exponentiations performed in the extract and signing queries, which is equal to t+O(qₑ+qₛ)E (compare equation (12)).

Therefore, the above analysis shows that the signature scheme of the example embodiments is secure in a UF-IDS-CMA sense.

An efficiency analysis of the signature scheme of the above example embodiments is provided below.

It is noted that exponentiation is equivalent to point multiplication in Elliptic Curve Cryptosystem (ECC) and multiplication is equivalent to point addition in ECC. Since a 160-bit ECC key offers more or less the same level of security as a 1024-bit Rivest-Shamir-Adleman (RSA) key, the signature scheme of the example embodiments may be implemented using ECC with |q|=160. |G| can be as small as 160 in the optimal case by choosing a suitable curve. Reference is made to D. Boneh, B. Lynn, and H. Shacham. Short Signatures from the Well Pairing. In Proc. ASIACRYPT 2001, volume 2248 of Lecture Notes in Computer Science, pages 514-532. Springer-Verlag, 2001. This setting is used in the following comparison with other schemes. The efficiency of the signature scheme of the example embodiments is compared to two different ID-based online/offline signature schemes, namely Shamir-Tauman's (ST) scheme (i.e. ID-based version, with a certificate attached as part of the signature) from Shamir and Y. Tauman. Improved online/offline signature schemes. In Proc. CRYPTO 2001, volume 2139 of Lecture Notes in Computer Science, pages 355-367. Springer-Verlag, 2001 and Xu-Mu-Susilo's (XMS) scheme from S. Xu, Y. Mu, and W. Susilo. Online/offline signatures and multisignatures for AVOD and DSR routing security. In ACISP '06, volume 4058 of Lecture Notes in Computer Science, pages 99-110. Springer-Verlag, 2006. The XMS scheme does not provide a multi-time version of the online/offline signature, in which offline storage can be used to re-use an offline signature part (ie. the XMS scheme is “one time”). However, the inventors recognised that equations (6) and (7) of the above example embodiments can be applied to the XMS scheme to produce an appropriate comparison. It is noted that the modified XMS scheme still requires pairing. It is further noted that, the ST scheme by Shamir et. al. cannot be extended to a multi-time version.

Denote C(θ) as the computation cost of operation θ and |λ| Alas the bits of λ. Denote E as the exponentiation in G (i.e. equivalent to scalar multiplication in ECC), M as the multiplication in G (i.e. equivalent to point addition in ECC), \tilde{m} as the modular multiplication in Z*_{q} and P as the pairing operation. Other operations such as addition in Z*_{q} and normal hashing are omitted.

Table 2 below tabulates the various computation costs of the ST scheme, the XMS scheme, and the signature scheme of the above example embodiments.

TABLE 2

| | | | Scheme of |
|---|---|---|---|
| | | | example |
| | ST scheme | XMS scheme | embodiments |
| Offline (One-time) | C(h) + C(σ_{g}) | 2E + \tilde{m} | 0 |
| Offline (Multi-time) | — | \|q\| · 2E | 0 |
| Online (One-time) | \tilde{m} | \tilde{m} | \tilde{m} |
| Online (Multi-time) | — | O(\|q\|) · 2M + \tilde{m} | O(\|q\|) · M + \tilde{m} |
| Verification | C(h) + C(σᵥ) + | 2P + 2E + M | 2E + M |
| | C(certᵥ) | | |

From Table 2, h represents a Chameleon hash operation, which requires at least one E computation. σ_{g} and σᵥ represent a normal signature generation and verification respectively, each requiring at least one E computation. In Table 2, certᵥ represents a certificate verification which also requires at least one E computation.

Table 3 below tabulates the offline storage costs and signature sizes of the ST scheme, the XMS scheme and the signature scheme of the above example embodiments.

TABLE 3

| | | | Scheme of example |
|---|---|---|---|
| | ST scheme | XMS scheme | embodiments |
| Offline | 2\|q\| + \|σ\| + \| | 2\|G\| + 2\|q\| ≈ 640 | \|G\| + \|q\| ≈ 320 bits |
| Storage | cert\| ≧ 800 bits | bits | |
| (One-time) | | | |
| Offline | | 2\|q\| · \|G\| ≈ 6.4 k | \|q\| · \|G\| ≈ 3.2 k |
| Storage | | bytes | bytes |
| (Multi-time) | | | |
| Size of | \|q\| + \|σ\| + \| | 2\|G\| + \|q\| ≈ 480 | 2\|G\| + \|q\| ≈ 480 bits |
| Signature | cert\| ≧ 640 bits | bits | |

In Table 3, |q| and |G| are both about 160 bits. |σ| represents the length of a normal digital signature, which is at least about 160 bits. |cert| represents the length of a digital certificate, which is at least about 320 bits.

From the above comparison, it is observed from Table 2 that the signature scheme of the example embodiments is more efficient than Shamir-Tauman's ST generic construction. When compared to the XMS scheme, from both Tables 2 and 3, an improvement of about 50% improvement in storage space and computation efficiency of both the offline and online stages can be achieved by using the signature scheme of the example embodiments. Furthermore, as the offline stage can be carried out by the PKG in the example embodiments, a signer does not incur any computation cost in the offline stage while the XMS scheme requires more than 320 E operations.

With regard to signature verification, it is emphasised that the example embodiments do not use any pairing operations while the XMS scheme requires pairing operations. Thus, the example embodiments can be suitable for use in a WSN environment where each sensor node typically does not have enough computation power for a pairing operation. Any node can generate and verify signatures using the signature scheme of the example embodiments. That is, the signature scheme of the example embodiments facilitates communication between nodes in an authenticated way.

In another example embodiment, an aggregation technique is provided for e.g. when a single user (or node) wishes to sign multiple messages.

It can be useful if a (single) sensor node can sign multiple messages, e.g. 77 messages, with the size of resulting signatures being significantly smaller than n times the size of a single signature. The technique can achieve about 50% improvement in computational cost as compared to running the online/offline signature generation sequentially for multiple messages. Such an aggregated (or shortened) signature can be of importance in applications e.g. in WSNs since reducing communication overheads in WSNs is desired as sensor nodes of WSNs are typically resource-constrained.

In the example embodiment, for aggregation, the online stage and the verification algorithms are modified.

In the example embodiment, in a Setup phase, let G be a multiplicative group with order q. A PKG selects a random generator g E G and randomly chooses xεZ*_{q}. The PKG sets X=g^{x}. Let H:{0,1}*→Z*_{q} be a cryptographic hash function. The public parameters param and master secret key msk are given by

param=(G,q,g,X,H) (13)

msk=x (14)

In an Extract Phase, to generate a secret key for an identity ID, the PKG randomly selects rεZ*_{q} and computes

R←g^{r} (15)

s←r+H(R,ID)x mod q (16)

The user secret key is (R,s). It is noted that a correctly generated secret key fulfils the following equality:

g^{s}=RX^{H(R,ID)} (17)

At an offline signature generation phase, i.e. at an offline stage, a signer computes:

Ŷᵢ←g⁻²^{ⁱ} for i=0, . . . |q|−1 (18)

In the example embodiment, this offline stage computation can be conducted by a third party or by the PKG. The resulting value Ŷᵢ for i=1, . . . , |q|−1 can also be provided as part of the public parameters.

At an online signature phase, i.e. at an online stage, the signer randomly selects yεZ*_{q}. Let yₗ[i] be the i-th bit of yₗ. Define Ψₗ⊂{1, . . . , |q|} to be the set of indices such that yₗ[i]=1. Denote mₗ as a message for l=1, . . . , n. Compute

$$\begin{matrix}{Y}_{l} ← {\prod }_{i ∈ {Ψ}_{l}} {\hat{Y}}_{i - 1} & ( 19 ) \\ {h}_{l} ← H ( Y , R , {m}_{l} ) & ( 20 ) \\ {z}_{l} ← {y}_{l} + {h}_{l} s mod q for l = 1 , … , n & ( 21 )\end{matrix}$$

Also compute

$$z = {\sum }_{l {=}_{.} 1}^{n} {z}_{l} \qquad ( 22 )$$

In the example embodiment, the aggregated signature is (Yₗ,R,z) for l=1, . . . , n.

In the example embodiment, a plurality of messages can be transmitted with an aggregated signature (Yₗ,R,z) for l=1, . . . , n. That is, the aggregated signature in the example embodiment is (Yₗ, Y₂, . . . , Yₙ, R, z). It will be appreciated that sending the aggregated signature is more efficient as compared to sending individual signatures (Y₁,R,z₁), (Y₂,R, z₂) . . . , (Yₙ, R, zₙ).

Therefore, the signature in aggregated form comprises a signature part Yₗ that varies corresponding to each one of the plurality of messages l=1, . . . . , n.

At a verification phase at a verifier, to verify the signature (Yₗ,R,z) for message mₗ and a signer identity ID for l=1, . . . , n, the verifier first computes hₗ←H(Y,R,mₗ) and checks whether

$${g}^{z} {=}^{?} ( {\prod }_{l = 1}^{n} {Y}_{l} ) {R}^{{\sum }_{l = 1}^{n} {h}_{l}} {X}^{( {\sum }_{l = 1}^{n} {h}_{l} ) H ( R , ID )} \qquad ( 23 )$$

The verifier accepts the message if the above verification equation is equal/correct. Otherwise, the verifier rejects the message.

Provided below is a description on how the verification equation is arrived at: Since Yₗ=g^{y}^{ₗ} for l=1, . . . , n,

$$\begin{matrix}( {\prod }_{l = 1}^{n} {Y}_{l} ) {R}^{{\sum }_{l = 1}^{n} {h}_{l}} {X}^{( {\sum }_{l = 1}^{n} {h}_{l} ) H ( R , ID )} = ( {\prod }_{l = 1}^{n} {Y}_{l} ) {g}^{r ( {\sum }_{l = 1}^{n} {h}_{l} )} {X}^{( {\sum }_{l = 1}^{n} {h}_{l} ) H ( R , ID )} \\ = {g}^{( {\sum }_{l = 1}^{n} {y}_{l} )} {g}^{( {\sum }_{l = 1}^{n} {h}_{l} ) ( r + xH ( R , ID ) )} \\ = {g}^{( {\sum }_{l = 1}^{n} {y}_{l} )} {g}^{s ( {\sum }_{l = 1}^{n} {h}_{l} )} \\ = {g}^{{\sum }_{l = 1}^{n} {y}_{l} ( {y}_{l} + {sh}_{l} )} \\ = {g}^{z} .\end{matrix}$$

Therefore, if the verifier can verify the verification equation, the signature is verified as correct.

In another example embodiment, a signature scheme is provided whereby an offline signature part is generated based on a secret key of a user/node. Compare equation (6). It is noted that the secret key equation, the offline signature equation and the verification equation differ from the above example embodiments.

In the example embodiment, at a Setup phase, let G be a multiplicative group with order q. A private key generator (PKG) selects a random generator gεG and randomly chooses xεZ*_{q}. The PKG sets X=g^{x}. Let H:{0,1}*→Z*_{q} be a cryptographic hash function. The public parameters param and master secret key msk are given by

param=(G,q,g,X,H) (24)

msk=x (25)

At an Extract phase, to generate a secret key for a user/node identity ID, the PKG randomly selects rεZ*_{q} and computes

R←g^{r} (26)

s←r⁻¹(H(ID)−xR)mod q (27)

In the example embodiment, a user secret key is (R,s). A correctly generated secret key fulfils the following equality:

R^{s}X^{R}=g^{H(ID)} (28)

At an offline signature generation phase, i.e. at an offline stage, using identity ID with the secret key (R,s), a signer computes:

Ŷᵢ←R⁻²^{ⁱ} for i=0, . . . |q|−1. (29)

It is noted that at the offline stage, knowledge of a message (to be signed) is not required.

At an online signature phase, i.e. at an online stage, the signer randomly selects yεZ*_{q}. Let y[i] be the i-th bit of y. Define Ψ⊂{1, . . . , |q|} to be the set of indices such that y[i]=1. Denote m as the message. Compute

$$\begin{matrix}Y ← {\prod }_{i ∈ Ψ} {\hat{Y}}_{i - 1} & ( 30 ) \\ h ← H ( Y , R , m ) & ( 31 ) \\ z ← y + hs mod q & ( 32 )\end{matrix}$$

In the example embodiment, the signature is (Y,R,z).

At a verification phase at a verifier, to verify the signature (Y,R,z) for a message in and a signer identity ID, the verifier first computes h←H(Y,R,m), R̅←R mod q and checks whether

$${g}^{hH} {=}^{?} {R}^{z} {YX}^{h \overline{R}} \qquad ( 33 )$$

The verifier accepts the message if equation (33) is equal/correct. Otherwise, the verifier rejects the message.

Provided below is a description on how the verification equation (33) is arrived at. It is noted that Y=R^{-y}. Thus,

$$\begin{matrix}{R}^{z} {YX}^{h \overline{R}} = {R}^{y + hs} {R}^{- y} {X}^{h ( R mod q )} \\ = {g}^{rhs} {g}^{xh ( R mod q )} \\ = {g}^{( rh ( {r}^{- 1} ( H ( ID ) - xhR ) mod q} \\ = {g}^{hH ( ID ) - hxR + xhR} \\ = {g}^{hH ( ID )}\end{matrix}$$

Therefore, if the verifier can verify that g^{hH(ID)} is equal to R^{z}YX^{h R̅} using the signature (Y,R,z) from the message sent from a node with identity ID, the signature is verified as correct.

The security analysis as well as storage cost and size for this example embodiment are substantially similar to the above example embodiments. Table 4 below tabulates the various computation costs of the ST scheme, the XMS scheme and the signature scheme of this example embodiment for referencing.

TABLE 4

| | | | Scheme of |
|---|---|---|---|
| | | | example |
| | ST scheme | XMS scheme | embodiments |
| Offline (One-time) | C(h) + C(σ_{g}) | 2E + \tilde{m} | E |
| Offline (Multi-time) | — | \|q\| · 2E | \|q\| · E |
| Online (One-time) | \tilde{m} | \tilde{m} | \tilde{m} |
| Online (Multi-time) | — | O(\|q\|) · 2M + \tilde{m} | O(\|q\|) · M + \tilde{m} |
| Verification | C(h) + C(σᵥ) + | 2P + 2E + M | 2E + M |
| | C(certᵥ) | | |

It is noted that this example embodiment still provides substantial computation cost savings over other schemes.

In another example embodiment, an aggregation technique is provided whereby an offline signature part is generated based on a secret key of a user/node.

In the example embodiment, in a Setup phase, let G be a multiplicative group with order q. A PKG selects a random generator gεG and randomly chooses xεZ*_{q}. The PKG sets X=g^{x}. Let H:{0,1}*→Z*_{q} be a cryptographic hash function. The public parameters param and master secret key msk are given by

param=(G,q,g,X,H) (34)

msk=x (35)

In an Extract Phase, to generate a secret key for an identity ID, the PKG randomly selects rεZ*_{q} and computes

R←g^{r} (36)

s←r⁻¹(H)ID)−x)mod q (37)

At an offline signature generation phase, i.e. at an offline stage, a signer computes:

Ŷ^{l}ᵢ←R⁻²^{ⁱ} for i=0, . . . |q|−1 and l=1, . . . n (38)

At an online signature phase, i.e. at an online stage, the signer randomly selects yεZ*_{q}. Let y[i] be the i-th bit of y. Define Ψₗ⊂{1, . . . , |q|} to be the set of indices such that y[i]=1. Denote mₗ as a message for l=1, . . . , n. Compute

$$\begin{matrix}{Y}_{l} ← {\prod }_{i ∈ Ψ} {\hat{Y}}_{i - 1}^{l} & ( 39 ) \\ {h}_{l} ← H ( {Y}_{l} , R , {m}_{l} ) & ( 40 ) \\ {z}_{l} ← {y}_{l} + {h}_{l} s mod q for l = 1 , … , n & ( 41 )\end{matrix}$$

Also compute

$$z = {\sum }_{l = 1}^{n} {z}_{l} \qquad ( 42 )$$

In the example embodiment, the aggregated signature is (Yₗ,R,z) for l=1, . . . , n.

At a verification phase at a verifier, to verify the signature (Yₗ,R,z) for message mₗ and a signer identity ID for l=1, . . . , n, the verifier first computes hₗ←H(Yₗ, R,mₗ) for l=1, . . . , n, R̅←R mod q and checks whether

$${g}^{( {\sum }_{l = 1}^{n} {h}_{l} ) H ( ID )} {=}^{?} {R}^{z} ( {\prod }_{l = 1}^{n} {Y}_{l} ) {X}^{( {\sum }_{l = 1}^{n} {h}_{l} ) \overline{R}} \qquad ( 43 )$$

The verifier accepts the message if the above verification equation is equal/correct. Otherwise, the verifier rejects the message.

Provided below is a description on how the verification equation is arrived at: Since Yₗ=R^{-y}^{ₗ} for l=1, . . . , n,

$$\begin{matrix}{R}^{z} ( {\prod }_{l = 1}^{n} {Y}_{l} ) {X}^{( {\sum }_{l = 1}^{n} {h}_{l} ) \overline{R}} = {R}^{{\sum }_{l = 1}^{n} ( {y}_{l} + {h}_{l} s )} {R}^{- ( {\sum }_{l = 1}^{n} {y}_{l} )} {X}^{( {\sum }_{l = 1}^{n} {h}_{l} ) ( R mod q )} \\ = {g}^{r ( {\sum }_{l = 1}^{n} {h}_{l} ) s} {g}^{x ( {\sum }_{l = 1}^{n} {h}_{l} ) ( R mod q )} \\ = {g}^{( r ( {\sum }_{l = 1}^{n} {h}_{l} ) ( {r}^{- 1} ( H ( ID ) - xR ) ) + x ( {\sum }_{l = 1}^{n} {h}_{l} ) R ) mod q} \\ = {g}^{( {\sum }_{l = 1}^{n} {h}_{l} ) H ( ID ) - ( {\sum }_{l = 1}^{n} {h}_{l} ) xR + x ( {\sum }_{l = 1}^{n} {h}_{l} ) R} \\ = {g}^{( {\sum }_{l = 1}^{n} {h}_{l} ) H ( ID )} .\end{matrix}$$

Therefore, if the verifier can verify the verification equation, the signature is verified as correct.

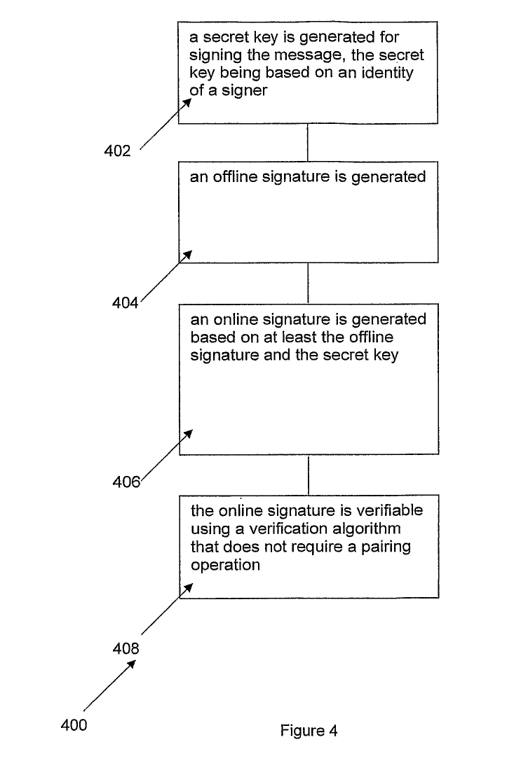

FIG. 4 is a schematic flowchart 400 for illustrating a method of signing a message in an example embodiment. At step 402, a secret key is generated for signing the message, the secret key being based on an identity of a signer. At step 404, an offline signature is generated. At step 406, an online signature is generated based on at least the offline signature and the secret key. At step 408, the online signature is verifiable using a verification algorithm that does not require a pairing operation.

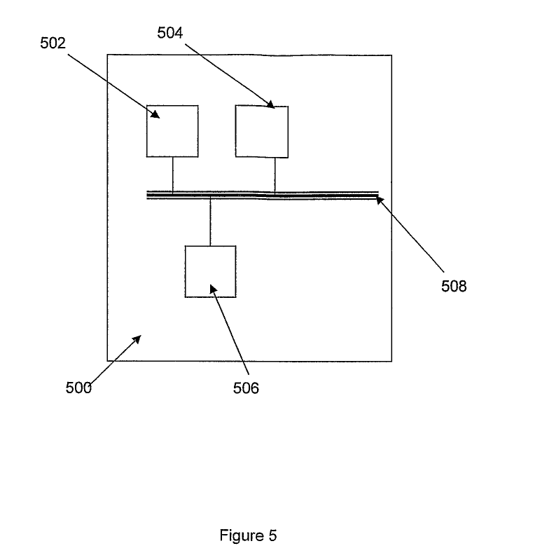

FIG. 5 is a schematic diagram for illustrating a base station for a WSN in an example embodiment. The base station 500 comprises a private key generator 502 for generating a secret key, the secret key being based on an identity of a node. The station 500 further comprises an offline signature generator 504 for generating an offline signature. The station 500 further comprises a verification module 506 for verifying an online signature generated by a signer for signing a message using a verification algorithm that does not require a pairing operation.

The components of the base station 500 communicate via an interconnected bus 508.

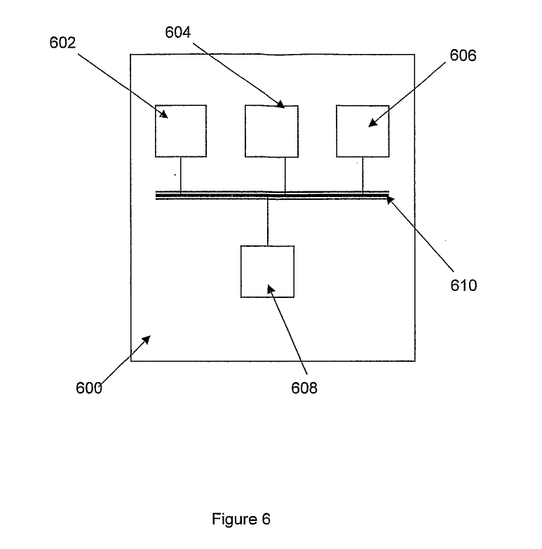

FIG. 6 is a schematic diagram for illustrating a node for a WSN in an example embodiment. The node 600 comprises a receiver 602 for receiving a secret key, an offline signature and a set of public parameters, the secret key being based on an identity of the node. The node 600 further comprises an online signature generator 604 for generating an online signature based on at least the offline signature and the secret key, the online signature for signing a message. The online signature is verifiable using a verification algorithm that does not require a pairing operation.

Preferably, the node 600 further comprises an offline signature generator 606 for generating an offline signature internal the sensor node. The node 600 preferably further comprises a verification module 608 for verifying an online signature generated by a signer (e.g. another node) for signing a message (e.g. an incoming message) using a verification algorithm that does not require a pairing operation.

The components of the node 600 communicate via an interconnected bus 610.

It will be appreciated that the base station 500 (FIG. 5) and the node 600 can be implemented as computing devices that typically include other components such as a computer processor, memory modules such as Random Access Memory (RAM) and Read Only Memory (ROM) chips, input modules such as a keyboard/keypad, output modules such as a display. Such computing devices can be connected to a network or network systems such as the internet via suitable means such as a wireless transceiver or a internet cables. The methods of the example embodiments can be implemented as software, such as a computer program being executed within the computing devices. Such application programs are typically supplied encoded on a data storage medium such as a CD-ROM or memory stick or in ROM chips and read utilising a corresponding data storage medium drive of the computing device. Intermediate storage of program data may be accomplished using RAM. The application program is read and controlled in its execution in the computing device by the computer processor.

For the above described example embodiments, the inventors have recognized that an identity-based system is suitable for WSNs. The absence of certificates can eliminate costly certificate verification processes. In addition, if a new node is added to a network, the other nodes do not need to obtain its certificate in order to communicate in a secure and authenticated way. Thus, communication overhead and computation cost can be reduced and can be a significant factor in the design of WSNs.

In the above described example embodiments, an efficient online/offline identity-based signature scheme suitable for WSNs can be provided. The example embodiments can remove the requirement of using certificates attached to signatures for verification. The example embodiments can provide less computation and storage cost (up to about 50% savings) as compared to current schemes. Further, the example embodiments do not require any pairing operations in both signature generation or verification. Therefore, the example embodiments can be implemented in WSN nodes. The example embodiments are suitable for node-to-node communication in WSNs, in the sense that no certificate is needed and computations are light enough to be executed. In addition, in example embodiments, offline information can be re-usable. Thus, a signer is not required to execute the offline algorithm every time a new message is to be signed. This can be useful in WSN nodes as the nodes do not then need to return to a base station for renewal of offline information.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method of signing a message, the method comprising,
generating a secret key for signing the message, the secret key being based on an identity of a signer;
generating an offline signature;
generating an online signature based on at least the offline signature and the secret key; and
wherein the online signature is verifiable using a verification algorithm that does not require a pairing operation.

2. The method as claimed in claim 1, wherein the verification algorithm is based on an inequality equation using the identity of the signer, the secret key, the message and the online signature.

3. The method as claimed in claim 1, wherein the generating the online signature is further based on the message.

4. The method as claimed in claim 1, wherein the offline signature is re-usable for signing multiple messages.

5. The method as claimed in claim 1, wherein the generating the offline signature is not based on the secret key, such that a party not holding the secret key is capable of generating the offline signature.

6. The method as claimed in claim 1, further comprising,
providing a set of public parameters param and a master secret key msk: param=(G,q,g,X,H) and msk=x;
wherein G is a multiplicative group with order q, gεG, xεZ*_{q}, X=g^{x} and H:{0,1}*→Z*_{q} is a cryptographic hash function.

7. The method as claimed in claim 6, wherein the generating the secret key comprises computing: R←g^{r} and s←r+H(R,ID)x mod q;
wherein the secret key is denoted as (R,s), the identity of said signer is denoted as ID and rεZ*_{q}.

8. The method as claimed in claim 7, wherein the generating the offline signature comprises computing Ŷᵢ←g⁻²^{ⁱ} for i=0, . . . |q|−1.

9. The method as claimed in claim 8, wherein the generating the online signature comprises computing:
$$Y ← {\prod }_{i ∈ Ψ} {\hat{Y}}_{i - 1} ;$$
h←H(Y,R,m) and z←y+hs mod q;
wherein yεZ*_{q}, y[i] is an i-th bit of y, Ψ⊂{1, . . . , |q|} is denoted as a set of indices such that y[i]=1 and the message is denoted as m; further wherein the online signature is denoted as (Y,R,z).

10. The method as claimed in claim 9, wherein the verification algorithm comprises,
computing h←H(Y,R,m); and
checking whether
$${g}^{z} {=}^{?} {YR}^{h} {X}^{hH ( R , ID )} .$$

11. The method as claimed in claim 1, further comprising applying an aggregation algorithm to a plurality of messages for deriving the online signature in an aggregated form, said aggregated form comprising a signature part that varies corresponding to each one of the plurality of messages.

12. The method as claimed in claim 11, further comprising, providing a set of public parameters param and a master secret key msk: param=(G,q,g,X,H) and msk=x;
wherein G is a multiplicative group with order q, gεG, xεZ*_{q}, X=g^{x} and H:{0,1}*→Z*_{q} is a cryptographic hash function.

13. The method as claimed in claim 12, wherein the generating the secret key comprises computing: R←g^{r} and s←r+H (R,ID)x mod q;
wherein the secret key is denoted as (R,s), the identity of said signer is denoted as ID and rεZ*_{q}.

14. The method as claimed in claim 13, wherein the generating the offline signature comprises computing Ŷₗ←g⁻²^{ⁱ} for i=0, . . . |q|−1.

15. The method as claimed in claim 14, wherein the deriving the online signature in an aggregated form comprises computing:
$${Y}_{l} ← {\prod }_{i ∈ {Ψ}_{l}} {\hat{Y}}_{i - 1} ;$$
hₗH(Y,R,mₗ), zₗ←yₗ+hₗs mod q and
$$z = {\sum }_{l = 1}^{n} {z}_{l} ;$$
wherein l=1, . . . , n, yεZ*_{q}, yₗ[i] is an i-th bit of yₗ, Ψₗ⊂{1, . . . , |q|} is denoted as a set of indices such that yₗ[i]=1 and mₗ denotes the plurality of messages for l=1, . . . , n, further wherein the online signature in an aggregated form is denoted as (Yₗ,R,z) for l=1, . . . , n.

16. The method as claimed in claim 15, further comprising, wherein the verification algorithm comprises,
computing hₗ←H(Y,R,mₗ); and
checking whether
$${g}^{z} {=}^{?} ( {\prod }_{l = 1}^{n} {Y}_{l} ) {R}^{{\sum }_{l = 1}^{n} {h}_{l}} {X}^{( {\sum }_{l = 1}^{n} {h}_{l} ) H ( R , ID )} .$$

17. The method as claimed in claim 1, wherein the offline signature is generated based on the secret key.

18. A base station for a wireless sensor network, the base station comprising,
a private key generator for generating a secret key, the secret key being based on an identity of a node;
an offline signature generator for generating an offline signature; and
a verification module for verifying an online signature generated by a signer for signing a message using a verification algorithm that does not require a pairing operation.

19. The base station as claimed in claim 18, wherein the verification algorithm is based on an inequality equation using an identity of the signer, a secret key of the signer, the message sent from the signer and the online signature generated by the signer.

20. The base station as claimed in claim 18, wherein the offline signature is re-usable for signing multiple messages.

21. The base station as claimed in claim 18, wherein the generating the offline signature is not based on the secret key, such that a party not holding the secret key is capable of generating the offline signature.

22. The base station as claimed in claim 18, wherein the private key generator provides a set of public parameters param and a master secret key msk: param=(G,q,g,X,H) and msk=x;
wherein G is a multiplicative group with order q, gεG, xεZ*_{q}, X=g^{x} and H:{0,1}*→Z*_{q} is a cryptographic hash function.

23. The base station as claimed in claim 22, wherein the private key generator generates the secret key of the node by computing: R←g^{r} and s←r+H(R,ID)x mod q;
wherein the secret key is denoted as (R,s), the identity of the node is denoted as ID and rεZ*_{q}.

24. The base station as claimed in claim 23, wherein the offline signature generator generates the offline signature by computing Ŷₗ←g⁻²^{ⁱ} for i=0, . . . |q|−1.

25. The base station as claimed in claim 22, wherein the verification module verifies the online signature generated by the signer by:
computing h←H(Y,R,m); and
checking whether
$${g}^{z} {=}^{?} {YR}^{h} {X}^{hH ( R , ID )} ;$$
wherein the message sent from the signer is denoted as m, the secret key of the signer is denoted as (R,s), the identity of the signer is denoted as ID and the online signature of the signer is denoted as (Y,R,z).

26. The base station as claimed in claim 22, wherein the verification module is capable of verifying an online signature in aggregated form (Yₗ,R,z) generated by a signer for signing a plurality of messages mₗ for l=1, . . . , n; and
wherein the verification module verifies the online signature in aggregated form by:
computing hₗ←H(Y,R,mₗ); and
checking whether
$${g}^{z} {=}^{?} ( {\prod }_{l = 1}^{n} {Y}_{l} ) {R}^{{\sum }_{l = 1}^{n} {h}_{l}} {X}^{( {\sum }_{l = 1}^{n} {h}_{l} ) H ( R , ID )} .$$

27. The base station as claimed in claim 18, wherein the generating the offline signature is based on the secret key.

28. A node for a wireless sensor network, the node comprising,
a receiver for receiving a secret key, an offline signature and a set of public parameters, the secret key being based on an identity of the node;
an online signature generator for generating an online signature based on at least the offline signature and the secret key, the online signature for signing a message;
wherein the online signature is verifiable using a verification algorithm that does not require a pairing operation.

29. The node as claimed in claim 28, wherein the verification algorithm is based on an inequality equation using the identity of the node, the secret key, the message and the online signature.

30. The node as claimed in claim 28, wherein the generating the online signature is further based on the message.

31. The node as claimed in claim 28, wherein the offline signature is re-usable for signing multiple messages.

32. The node as claimed in claim 28, wherein the offline signature is not based on the secret key, such that a party not holding the secret key is capable of generating the offline signature.

33. The node as claimed in claim 28, wherein the receiver receives the secret key denoted as (R,s), the set of public parameters denoted as param=(G,q,g,X,H) and the offline signature denoted as Ŷᵢ←g⁻²^{ⁱ} for i=0, . . . |q|−1.

34. The node as claimed in claim 33, wherein the online signature generator generates the online signature by computing
$$Y ← {\prod }_{i ∈ Ψ} {\hat{Y}}_{i - 1} ;$$
h←H (Y,R,m) and z←y+hs mod q;
wherein yεZ*_{q}, y[i] is an i-th bit of y, Ψ⊂{1, . . . , |q|} is denoted as a set of indices such that y[i]=1 and the message is denoted as m; further wherein the online signature is denoted as (Y,R,z).

35. The node as claimed in claim 28, wherein the online signature generator is capable of applying an aggregation algorithm to a plurality of messages for deriving the online signature in an aggregated form, said aggregated form comprising a signature part that varies corresponding to each one of the plurality of messages.

36. The node as claimed in claim 35, the deriving the online signature in an aggregated form comprises computing:
$${Y}_{l} ← {\prod }_{i ∈ {Ψ}_{l}} {\hat{Y}}_{i - 1} ;$$
hₗ←H(Y,R,mₗ),zₗ←yₗ+hₗs mod q and
$$z = {\sum }_{l = 1}^{n} {z}_{l} ;$$
wherein the set of public parameters is param=(G,q,g,X,H), the set of l=1, . . . , n, yεZ*_{q}, yₗ[i] is an i-th bit of yₗ, Ψₗ⊂{1, . . . , |q|} is denoted as a set of indices such that yₗ[i]=1 and mₗ denotes the plurality of messages for l=1, . . . , n, further wherein the online signature in an aggregated form is denoted as (Yₗ,R,z) for l=1, . . . , n.

37. The node as claimed in claim 28, further comprising a verification module for verifying an online signature generated by a signer for signing a message using a verification algorithm that does not require a pairing operation.

38. The node as claimed in claim 37, wherein the verification module verifies the online signature generated by the signer by:
computing h←H(Y,R,m); and
checking whether
$${g}^{z} {=}^{?} {YR}^{h} {X}^{hH ( R , ID )} ;$$
wherein the set of public parameters is param=(G,q,g,X,H), the received message sent from the signer is denoted as m, a secret key of the signer is denoted as (R,s), an identity of the signer is denoted as ID and the online signature of the signer is denoted as (Y,R,z).

39. The node as claimed in claim 37, wherein the verification module is capable of verifying an online signature in aggregated form (Yₗ, R,z) generated by a signer for signing a plurality of messages mₗ for l=1, . . . , n; and
wherein the verification module verifies the online signature in aggregated form by:
computing hₗ←H(Y,R,mₗ); and
checking whether
$${g}^{z} {=}^{?} ( {\prod }_{l = 1}^{n} {Y}_{l} ) {R}^{{\sum }_{l = 1}^{n} {h}_{l}} {X}^{( {\sum }_{l = 1}^{n} {h}_{l} ) H ( R , ID )} ;$$
wherein the set of public parameters is param=(G,q,g,X,H).

40. The node as claimed in claim 28, further comprising an offline signature generator for generating the offline signature internal the node.

41. The node as claimed in claim 28, wherein the generating the offline signature is based on the secret key.

42. A wireless sensor network, the network comprising,
a base station; and
one or more wireless sensor nodes;
wherein the base station comprises,
a private key generator for generating a secret key, the secret key being based on an identity of a node;
an offline signature generator for generating an offline signature; and
a verification module for verifying an online signature generated by a signer for signing a message using a verification algorithm that does not require a pairing operation; and
at least one wireless sensor node comprises,
a receiver for receiving a secret key, an offline signature and a set of public parameters, the secret key being based on an identity of the node;
an online signature generator for generating an online signature based on at least the offline signature and the secret key, the online signature for signing a message;
wherein the online signature is verifiable using a verification algorithm that does not require a pairing operation.

43. A computer readable data storage medium having stored thereon computer code means for instructing a computer processor of a base station for a wireless sensor network to execute the steps of:
generating a secret key, the secret key being based on an identity of a node;
generating an offline signature;
verifying an online signature generated by a signer for signing a message using a verification algorithm that does not require a pairing operation.

44. A computer readable data storage medium having stored thereon computer code means for instructing a computer processor of a node for a wireless sensor network to execute the steps of:
receiving a secret key, an offline signature and a set of public parameters, the secret key being based on an identity of the node;
generating an online signature based on at least the offline signature and the secret key, the online signature for signing a message;
wherein the online signature is verifiable using a verification algorithm that does not require a pairing operation.
